(19) United States
(12) Patent Application Publication
(10) Pub. No.: US 2011/0088535 A1
(43) Pub. Date: Apr. 21, 2011

(54) DIGITAL INSTRUMENT

(75) Inventor: Michael Zarimis, Five Dock (AU)

(73) Assignee: Misa Digital Pty Ltd., Mona Vale (AU)

(21) Appl. No.: 12/879,540

(22) Filed: Sep. 10, 2010

Related U.S. Application Data
(63) Continuation-in-part of application No. PCT/AU2009/000226, filed on Mar. 2, 2009.

(30) Foreign Application Priority Data
Mar. 11, 2008 (AU) 2008901236

(51) Int. Cl. G10H 7/00

(52) U.S. Cl. 84/645

(57) ABSTRACT

A digital guitar includes a two or three-axis input on the body and an array of inputs on the neck. The two or three axis input serves as an actuator to commence generation of an output representing sounds. The array of inputs on the neck provide for player control of the sounds represented by the output. The different axes of the two or three axis input provide for an ability to configure the instrument to simultaneously control multiple different characteristics of the output from the guitar. The two or three axis input on the body of the guitar may be a touch pad or touch and display screen. The display screen provides visual feedback to the player.

### CLAIM OF PRIORITY

This application is a continuation-in-part under 35 U.S.C. 111(a) and claims the benefit of priority under 35 U.S.C. §120 to International Patent Application No. PCT/AU2009/000226, filed on Mar. 2, 2009, and published in English on Sep. 17, 2009, as WO 2009/111815 A1, which claims the benefit under 35 U.S.C. 119 to Australian Patent Application No. 2008901236, filed on Mar. 11, 2008, the benefit of priority of each of which is claimed hereby, and each of which are incorporated by reference herein in its entirety.

### TECHNICAL FIELD

The present invention relates to the field of digital instruments, and more particularly to a digital guitar.

### BACKGROUND

The MIDI communication protocol enables digital instruments to communicate in a standardized manner. Various instruments and other devices have been produced that utilise this protocol.

Guitar-like MIDI controllers have been developed. These guitar-like MIDI controllers (hereafter “MIDI guitars”) receive the input of a user and thereafter control the output of sound via a sound module that either incorporates a synthesiser or alternatively a collection of audio samples. Existing MIDI guitars, like their contemporary counterparts, utilise strings in their design. The electronic components in these MIDI guitars resolves pitch information from the vibrations detected in the strings and thereafter provide electronic output instructions, which are interpreted by the sound module and used to output the corresponding note that the instrument originally played.

There are problems associated with the prior art MIDI guitars. In particular, the pick ups and circuitry used to register the vibrations in the strings and output an electrical control signal cause delays between the playing and outputting of notes. There is also the issue of false notes being registered (an effect known as ‘ghosting’), which also affects the output.

For many existing MIDI guitars, the use of strings means that the guitars have to be tuned like normal guitars and are susceptible to going out of tune for a variety of reasons (changes in humidity, accidental bumping). Furthermore these MIDI guitars are susceptible to string breakages.

Also, as the MIDI guitars are controllers, capable of applying a multitude of effects, existing MIDI guitars are unable to apply all of the effects that were otherwise possible through pairing with a sound module, due to constraints in user interface layout. Accordingly, existing MIDI guitars may require “add-ons” or other associated devices to provide those alternative input means, for instance, through the use of an attached foot controller.

Alternatively, extra knobs, sliders and/or bars may be introduced to the MIDI guitar's body providing extra inputs, but these are relatively few in number. Furthermore these add-ons may not be aesthetically pleasing to the guitar player, as the add-ons may clash with the guitar's original design, and hinder playing comfort due to positioning or orientation of the controls.

### SUMMARY OF INVENTION

Embodiments of the invention relate to an instrument in the form of a digital guitar that includes a two or three-axis input on the body and an array of inputs on the neck. The two or three axis input serves as an actuator to commence generation of an output representing sounds. The array of inputs on the neck provide for player control of the sounds represented by the output. The different axes of the two or three axis input provide for an ability to configure the instrument to simultaneously control two or three different characteristics of the output from the guitar. The two or three axis input on the body of the guitar may be a touch pad or touch and display screen. In the case of a multi-touch input, each touch may be characterised by its own 2-axis or 3-axis coordinate.

Other embodiments relate to a stringless digital instrument comprising input means adapted to receive the player's fingers (or other input type such as a stylus) and generating electrical signals indicating the position of the fingers (or stylus), and settings desired by the user, a display for indicating the settings of the digital instrument, and a microcontroller adapted to receive the electrical signals representing the position of one or more fingers of the user and inputted settings, and generate as a result, electrical output signals. The stringless digital instrument further comprises output means for outputting the electrical output signals to a sound module or computer.

The output means may be a MIDI or open sound control (OSC) out module and associated port. The input means for receiving the settings desired by the user may be buttons. These buttons may be capable of providing an electrical signal indication of the pressure applied to them, capable of after-touch and continual pressure monitoring. The array of buttons may be adapted such that each button may be lit up. The input means may obtain positional information and may consist of separate input means for obtaining the position of each hand of the user. The input means for obtaining positional information for one hand may comprise an array of touch actuated switches located on a neck of the digital instrument and for the other hand a touch sensor pad, which may provide positional information in at least the x and y axis'. In some embodiments, the touch sensor pad is adapted to provide positional information in the x, y and z axis, where the z axis is a reference to depth, pressure or surface area in that the single touch sensor pad would measure the depth, pressure or surface area of the touch which gives an indication of the pressure used.

The touch sensor pad may be a touch and display screen, which functions as the digital instrument's display and input means for receiving the settings desired by the user. The touch and display screen may be activated by the finger or any other stylus, such as a traditional guitar pick. The touch and display screen may display representations of strings of a guitar and/or note information such as pitch. A control ball or similar, for controlling aspects of the output of the guitar, such as volume, distortion etc may also be displayed.

The digital instrument may also include an electronic input interface for connecting it to an external information processing unit such as a personal computer. The connection of the digital instrument to an external information processing unit may be via a USB connection, but may also be via a MIDI connection, serial connection, a Firewire connection, Bluetooth, Ethernet or Wi-Fi connection. The connection may be by wires or wireless. Updates to the microcontroller's software and pre-configured settings may be received via the USB connection or via any of the aforementioned connection methods.

The microcontroller may be adapted to receive data that is interpreted to instruct the user on which of the array of buttons to touch by lighting the desired button up so as to obtain a certain sound or melody.

### BRIEF DESCRIPTION OF THE DRAWINGS

In order that the invention may be readily understood and put into practical effect, reference will now be made to the accompanying drawings, in which:

FIG. 1 is a perspective view of first embodiment of a digital guitar.

FIG. 2 is a perspective view of a second embodiment of a digital guitar.

FIG. 3 is a schematic of selected components of a digital instrument.

FIG. 4 is a schematic of an alternative arrangement of a digital instrument.

FIG. 5 shows a structure of a micro-switch for a digital guitar.

FIG. 6 is a schematic of circuitry for buttons provided on a neck of a digital guitar.

FIG. 7 is a screen display that a processing unit of a digital guitar may cause to be displayed on a touch and display screen provided on the body of the digital guitar.

FIG. 8 is a flow diagram of a process implemented by a processing unit of a digital guitar.

### DESCRIPTION OF EMBODIMENTS

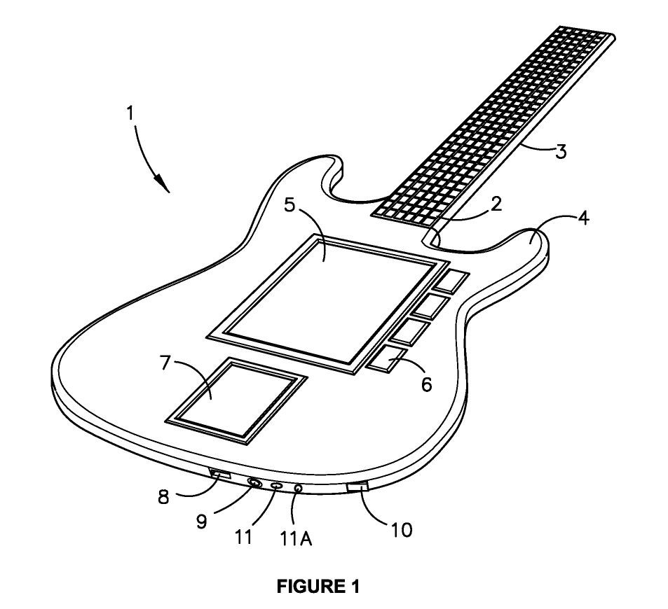

Shown in FIG. 1 is a digital guitar 1. The digital guitar 1 includes a plurality of touch actuated switches, in this embodiment, buttons 2, arranged in an array on the neck 3 of the digital guitar 1.

In alternative embodiments, the neck 3 of the digital guitar 1 may have on its face a single touch sensor pad, which registers the position of the user's hand, in particular the user's fingers on the touch sensor pad, at a plurality of positions. In these alternative embodiments, the touch sensor pad is a multi-touch pad, which allows a plurality of touches to be simultaneously detected. In further alternative embodiments, the neck 3 of the digital guitar 1 may have an array of individual touch sensors on its face to achieve the same end.

In the depicted embodiment of the invention in FIG. 1 the buttons 2 are electrodes formed in an array on a printed circuit board (PCB) and overlaid with a silicone keypad carrying a conductive material, for example a carbon or gold switch contact in the form of a pill or conductive ink. The switch contact of a button 2 closes a circuit on the PCB when the button is pressed against the PCB by pressing the part of the silicone keypad that forms that button 2. The closing of the circuit is registered by the microcontroller of the digital guitar 1. The microcontroller may sample the switches of each button 2 continuously, for example at a rate of 1 kHz, enabling detection of the duration of holding of a button 2, in addition to detection of the timing of the original depression of the button.

Above each button 2 of the silicone keypad there is a key cap, which provides a hard surface for each button. Lights (not shown) may be integrated into or with the buttons 2 so that the individual buttons light up when pressed by a user. The key cap may therefore be a transparent or translucent material. In embodiments that use one or more touch sensors on the neck instead of the keypad, the touch sensors may light up when pressed.

The lights on the neck may be used to indicate which button 2, which touch sensor, or which part of the touch sensor, the user should touch next in sequence, in accordance with data received from an information processing unit, which may be on-board the guitar or may be an external unit, for example a computer.

Each row of buttons 2 (representing a virtual string) may be configured with its own tuning, meaning any guitar tuning may be instantly replicated on the instrument. The guitar can be set up to output all the virtual strings to the same MIDI channel, or each virtual string to a separate MIDI channel, allowing multiple instruments to be controlled with different rows of buttons 2 (virtual strings). Furthermore the user can choose to invert the x or y axis used as a coordinate system to describe the sensor array (so that the highest point is the lowest point and the lowest point becomes the highest).

The digital guitar 1 further includes a touch pad 5, setting buttons 6, and a display screen 7 located on the body 4 of the digital guitar. The user of the digital guitar 1 first uses setting buttons 6 to determine the appropriate settings for the digital guitar, which are thereafter displayed through in-built LED indicators (not shown) in the setting buttons 6 themselves, or through the display screen 7.

Instructions regarding the state and settings of the digital guitar 1 include, but are not limited to:
assigning different musical notes to different neck buttons, or different musical tunings to different button rows;
specifying whether the x-axis of the touch pad 5 is to control the pitch of the notes or some other control. This could be by using the buttons to specify the MIDI control change number to associate the x-axis (the direction in line with the neck 3 or in other words the direction that would be along a string for a conventional guitar) with, where the MIDI control change number corresponds to a certain effect or similar on the receiver/sound module/synthesizer;
whether touch sensor actuation is required to output note data.

In one embodiment, one of the setting buttons 6 toggles ‘TAP’ mode on and off. TAP mode determines whether the touch pad 5 must be pressed to output note data, or whether the notes are activated as soon as the buttons 2 are pressed, similar to that of a keyboard. In one embodiment, one of the setting buttons 6 toggles ‘STRUM’ mode. STRUM mode determines whether the user must simply touch the touch pad 5 to output any notes indicated by the depression of one or more of the buttons 2, or whether the user must actually slide his/her finger across the touch pad 5 in the y-axis direction (transverse to the x-axis) to output the notes pressed. In one embodiment, one of the setting buttons 6 cycles through various effects (including MIDI control change numbers) to determine which effect is controlled by the x-axis of the touch pad 5. In one embodiment, one of the setting buttons 6 determines which effect is controlled by the y-axis of the touch pad 5.

Unlike prior art MIDI guitars that provide a single axis of sense, the use of the x-y touch pad 5 allows two parameters to be controlled simultaneously for greater control with a single input. The large size of the touch pad 5 is surprisingly more ergonomic, intuitive and aesthetically pleasing than alternative 2-axis input methods, such as small joysticks.

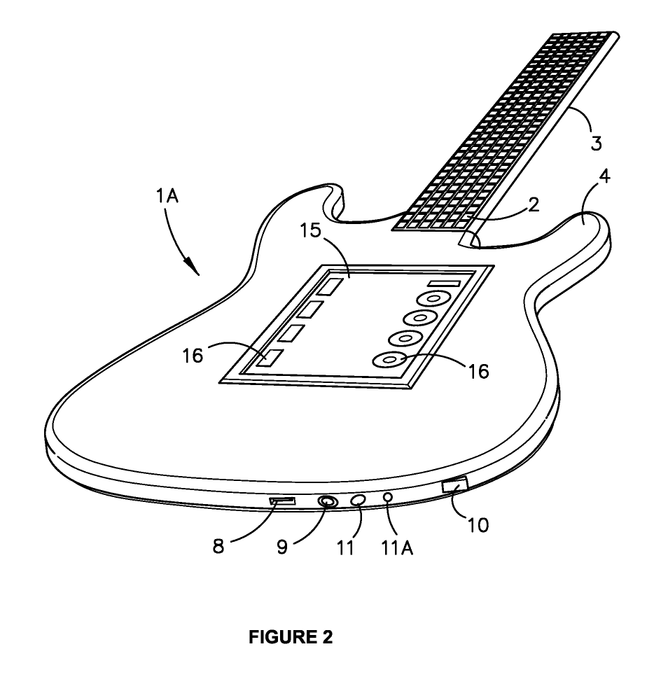

In an alternate embodiment of a digital guitar 1A, as depicted in FIG. 2, the touch pad and the display screen are incorporated into an integrated touch and display screen 15. In this embodiment, the user enters and views entered settings via the touch and display screen 15, which provides both a displayed graphical user interface and a mechanism for inputting instructions into the digital guitar.

The touch and display screen 15 graphical user interface features virtual controls, such as virtual buttons 16, which control some aspects of the digital guitar 1 or provide input to access system settings. Examples of controllable aspects are described herein above with reference to the buttons 6. Alternatively, or in addition, physical controls, including knobs and sliders, may be incorporated into the body of the guitar for controlling certain often used effects and settings of the digital guitar.

The touch and display screen 15 is in one embodiment a square or rectangular pad that senses either two axes (x and y) or three axes (x, y, and z) of position. The z axis is the pressure, or alternatively surface area, applied to the touch and display screen 15. Such a device may be, but is not limited to, a resistive, capacitive, infrared or surface acoustic wave touch screen. It will be appreciated that the type of the device will determine whether or not pressure can be usefully detected, which in turn dictates whether the digital guitar can have two or three axis control. Alternatively the touch and display screen 15 may incorporate optical sensor technology or touch sensors that utilise the frustrated total internal reflection property of materials such as acrylic. The touch and display device may measure absolute position, relative position or a combination of both.

The touch and display screen, and specifically the sensor aspect of it is also responsible for actuating the output. Its function, in this case, is the same as was described previously with respect to the touch pad 5.

The digital guitars 1, 1A of FIG. 1 and FIG. 2 also feature a USB port 8 and MIDI output port 9. In embodiments where OSC data is being outputted, an additional Ethernet port (not shown) may also be included. The digital guitars 1, 1A also include an audio output port 11, which may be in the form of an audio jack. Accordingly, the digital guitar 1, 1A may include, for example as part of the microcontroller 30, a software-implemented synthesizer. Alternatively, the digital guitar 1,1A may include a hardware synthesizer to produce driving signals based on the user inputs to the digital guitar.

The user turns the digital guitar off and on via power switch 10. A power supply for the digital guitar may be provided through the USB port 8 or through a power socket 11A.

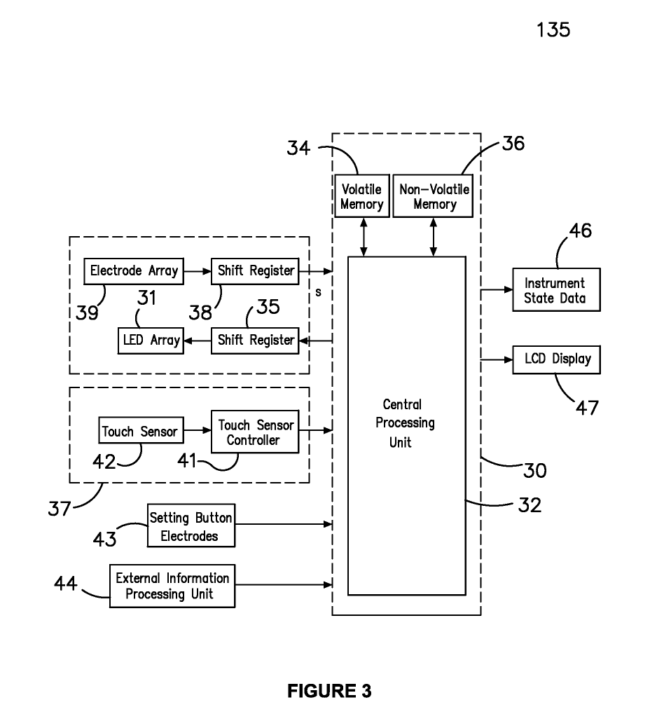

FIG. 3 shows a high-level circuit diagram of the digital guitar 1. The microcontroller 30 includes the central processor 32, volatile 34 and non-volatile 36 memory storage and components required to interpret the sensor outputs and convert the signals into an appropriate output signal in a data stream. The microcontroller 30 receives input from neck electronics 33, touch sensor electronics 37, setting button electrodes 43 and if connected, an external information processing unit 44 such as a PC.

The microcontroller 30 outputs information state data 46. The state data 46 collectively includes all information output through the ports of the digital guitar, including the USB port 8, the MIDI port 9, the OSC port if provided, and the audio port 11. Certain embodiments of the digital guitar may also have a wireless port for wireless communications with a device.

The microcontroller 30 controls the information displayed on LCD display(s) 47. The LCD displays for the digital guitar 1 are the touch pad 5, setting buttons 6 and display screen 7. For the digital guitar 1A the LCD display is the touch and display screen 15. A suitable microcontroller 30 is a processor from the ARMS processor family.

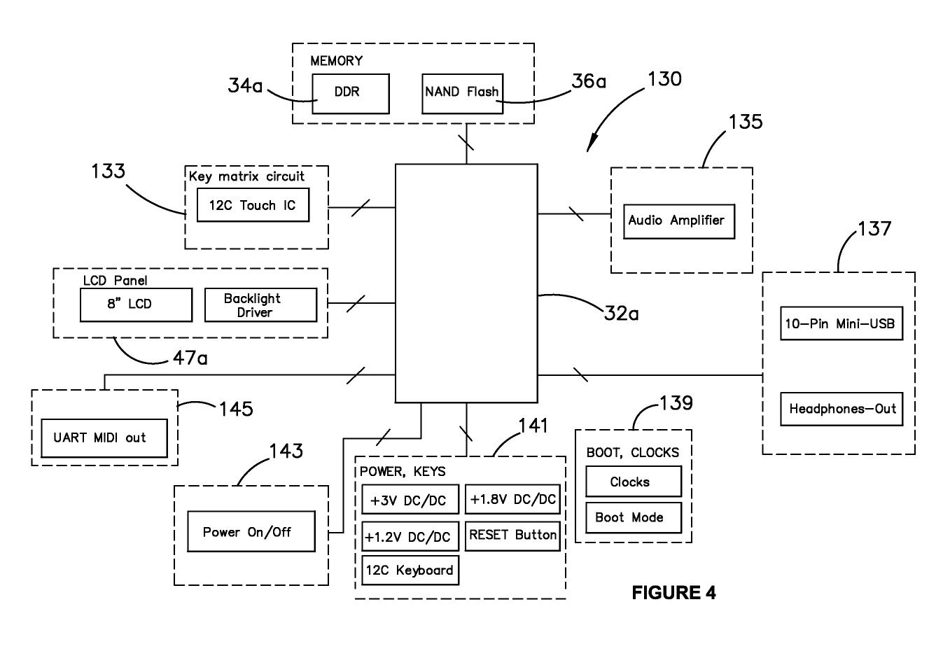

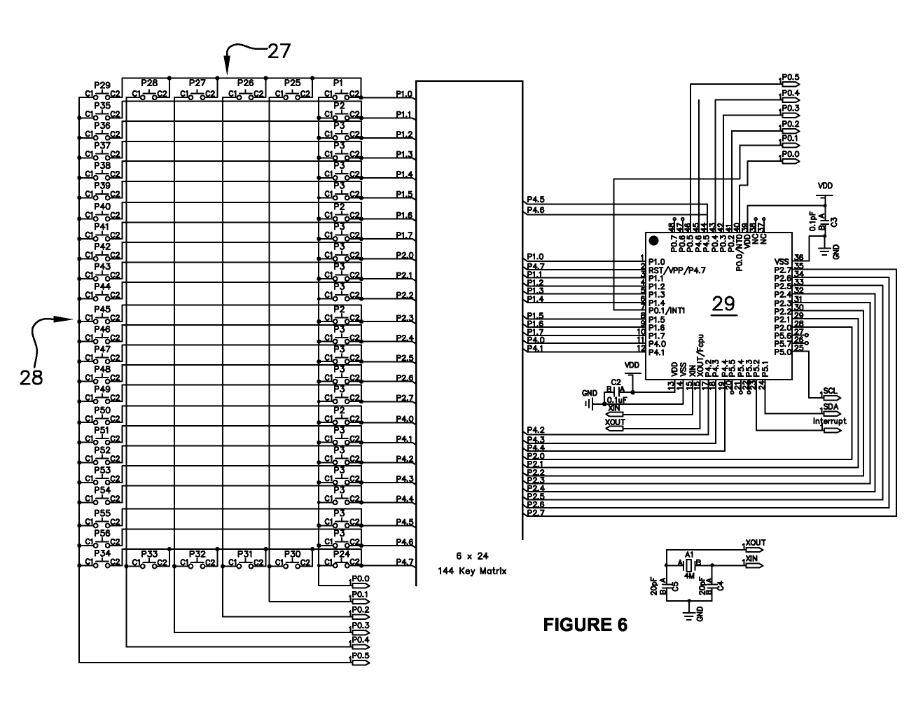

In one arrangement, neck electronics 33 includes electrodes 39 and a shift register 38 for receiving electrical signals from the buttons 2, LED array 31 and shift register 35 for lighting up buttons 2 in the neck 3. The shift registers 38 and 35 are connected to an input and output of the microcontroller 30 respectively. Alternatively, the neck electronics may include a key matrix that connects directly to the microcontroller, as shown for example in FIGS. 4 and 6.

The touch pad electronics 37 (for the touch pad 5 or touch and display screen 15) comprise touch sensor 42 and touch sensor controller 41 for receiving information regarding the position of any touches made by the user on the touch sensor 42.

The microcontroller 30 connects to the external information processing unit 44 via a USB interface (not shown), or via any of the aforementioned connection methods, which can be used to upload firmware updates and files used to configure the settings of the digital guitar 1 such as personalising the graphical interface or synthesizer settings. For example, the user may choose to download new graphical interfaces or software synthesizers off the Internet. The user may also save guitar settings on the external unit 44. In alternate embodiments, the microcontroller 30 is adapted to connect via the USB port (or other similar electronic interface) to local storage modules such USB memory sticks or digital media player devices for receiving firmware upgrades, or personalised settings that might be conveniently carried on the user's person.

The microcontroller 30 also provides digital output via the MIDI output port (or Ethernet port depending on the protocol of output desired) whereupon the MIDI socket is used to connect the digital guitar 1 to a sound module. Through the MIDI output port the digital guitar 1, 1A outputs, in the MIDI protocol, the sounds generated by the guitar.

The processes performed by the microcontroller 30 include receiving into volatile memory 34 signals indicating actuation of the neck buttons 2 and operation of the touch sensor 5 or touch and display screen 15. The microcontroller determines, based on the current configuration of the digital guitar, how the inputs are to be interpreted and then processes the inputs, and provides the output.

A similar circuit to that shown in FIG. 3 may be used for the digital guitar 1A, with appropriate changes to reflect the components of the digital guitar, for example with the setting button electrodes 43 being effectively incorporated into the touch sensor electronics 37.

An alternative arrangement is shown in FIG. 4. The arrangement uses a key matrix circuit 133 rather than the neck electronics 33 that uses shift register. As discussed below with reference to FIG. 6, the key matrix circuit defines the keys with reference to a two-dimensional matrix. The key matrix circuit 133 is in data communication with a controller arrangement 130 that includes microprocessor 32a and memory, for example non-volatile flash memory 36a and double-data-rate (DDR) memory 34a.

The microprocessor 32a is also in data communication with LCD panel 47a, which may include an LCD display and a backlight driver for the display. The microprocessor may also communicate with a universal asynchronous receiver/transmitter UART MIDI port 145 and other input/output ports 137. These may include, for example, a headphone out connection and a 10-pin mini-USB connection. The microprocessor 32a may also communicate with audio amplifier 135. A power source 141 is provided for the controller arrangement 130 and also an on/off switch 143. The controller arrangement also includes boot and clock controls 139.

In a further alternative the controller arrangement 130 may include a digital signal processing (DSP) chip. For example, the DSP chip may be located between the processor 32a and the amplifier 135. The DSP chip may perform wavetable synthesis or any other type of audio synthesis. A benefit of using a DSP chip is that it may reduce the processing load on the processor 32a to perform the synthesis algorithms.

As a MIDI controller, the digital guitar 1 is able to be connected to a variety of standard MIDI devices including personal computers for a variety of purposes. In one embodiment the digital guitar can be connected to a computer and information uploaded into the device which causes a sequence of buttons 2 to light up, which the user must follow and press in order to play a musical piece.

In alternative embodiments, the switches of each button on the neck of the digital guitar may be individual micro-switches. An advantage of using individual micro-switches in comparison to the silicone keypad arrangement is that each micro-switch can provide substantially the same resistance to depression. When a silicone keypad is used to implement buttons having a layout of a guitar, the buttons nearer the base of the guitar (ie nearer the body 4 of the guitar) may be closer together and smaller than those further from the base of the guitar, resulting in a different resistance to depression for different buttons.

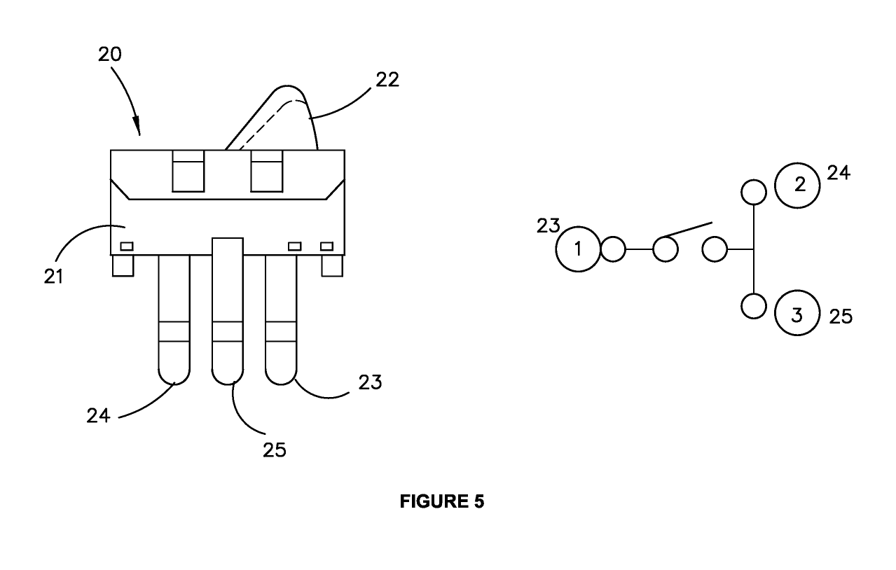

An example of a structure of a suitable micro-switch 20 is shown in FIG. 5. The micro-switch 20 includes a housing 21, a button 22, and terminals 23-25. The button 22 is biased in its upward position by an internal spring. The micro-switch 20 is normally open, so that in its upwards position, an open circuit exists between terminal 23 and terminals 24 and 25, which are short-circuited together. When the button 22 is depressed, then the circuit between terminal 23 and terminals 24 and 25 is closed. The micro-switch 20 may be a surface-mount component for mounting on a circuit board extending along the neck of the digital guitar.

A circuit arrangement for the key matrix 133 is shown in FIG. 6. The micro-switches 20 are arranged in an array 26 with rows 27 and columns 28. For example, to emulate a conventional six string guitar, the switches may be arranged in six parallel rows, with each row extending along the neck of the guitar, and in twenty-four columns.

Each terminal 23 is connected to a power supply held at the supply voltage, corresponding to a logical high for the processing unit 29. Each terminal 24 of a micro-switch 20 is connected in series to the terminal 24 of the other micro-switches in the same row as that micro-switch. Each terminal 25 of a micro-switch 20 is connected in series to the terminal 25 of the other micro-switches in the same column as that micro-switch. These series connected rows and columns of terminals are each separately connected to an input of the processing unit 29. Therefore, for the example of an array having six rows and twenty-four columns, there are 144 keys. Different rows of the matrix may be turned on and scanned in sequence to provide inputs to the processing unit 29. The processing unit 29 identifies which micro-switch has been depressed by evaluating which inputs are at a logical high. Data from processing unit 29 is communicated to processing unit 30 or 130.

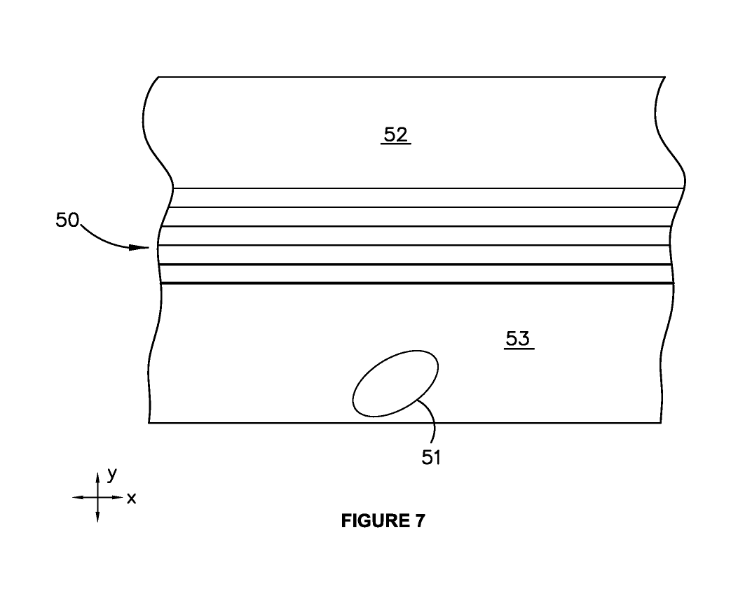

FIG. 7 shows an example of a screen display that the processing unit 30 or 130 may cause to be displayed on the touch and display screen 15. The screen display includes a representation of six strings 50 across the display. The number of strings displayed will generally correspond to the number of rows in buttons 2 provided on the neck of the digital guitar. The screen display also includes a representation of a control ball 51. Different embodiments may display only the strings 50 and not the control ball 51 or only the control ball 51 and not the strings 50. The manner of representation of the strings 50 and the control ball 51 are a matter of artistic choice. For example, in some embodiments the representations may be recognisable as strings while in other embodiments abstract representations not recognisable as strings may be used. In some embodiments a graphical interface that represents a synthesizer panel may be displayed, in which case the inputs to the touch and display screen 15 are processed to reflect the different method of playing the instrument required to match the representations displayed.

In embodiments where strings are displayed, the touch and display screen 15 detects when a player of the digital instrument provides a user input by touching the display at the location of a displayed string 50. The processing unit 30, 130 receives the user input and generates an output in response. The generated output depends on the configuration of the processing unit 30, 130 and the buttons 2, if any, that have been depressed by the player in the row corresponding to the string that has been touched. For example, if the player touches a single string, then the note within the span of the played string may be dictated by the button 2 that has been depressed in the row corresponding to that string and the frequency span of the string may be configurable either through a configuration screen on the touch and display screen 15 or through another input to the digital guitar, such as a communication through the USB port or MIDI port or an additional button provided on the digital guitar. Conventionally, an octave is divided into twelve semitones. Thus, a row having 24 buttons may represent a span of two octaves.

The digital guitar allows the player to select more than one and less than all of the strings. For example, the player may select three strings either by individually touching them simultaneously or in quick succession or by touching the display screen on one of the strings and dragging their finger, or stylus if used, across the strings to be selected. In some embodiments the processing unit 30, 130 may be configured to receive this input and react in a way that emulates a conventional guitar.

In some embodiments different outputs may be produced depending on where along the strings 50 the player touches the touch and display screen 15. For example, the processing unit 30, 130 may output sounds with different distortion depending on what part of the string is touched. One implementation of this example is that touching the screen in the right-most third of the touch and display screen 50 (adopting as a frame of reference the orientation shown in FIG. 7) results in the processing unit 30, 130 outputting sound information corresponding to a classical guitar, whereas touching the screen outside of the right-most third results in distortion of the sound, the amount of distortion depending on how far to the left the player has touched the string(s) 50. What characteristic is varied responsive to touches at different locations along the strings is in some embodiments a configurable parameter, for example a MIDI parameter from 0 to 127 depending on the location of the touch. Other examples of characteristics include pitch and volume.

In some embodiments a player can indicate an intention to select all strings 50 by either touching the touch and display screen 15 over the strings 50 or by touching the display screen 15 in one or more other particular locations outside the area of the strings 50. For example, the processing unit 30, 130 may interpret an input in the form of a touch in the region above the strings 52 or in the region below the strings 53 as an input selecting all strings 50. An exception to this is an input detected at the location where the control ball 51 is displayed, in which case the processing unit 30, 130 produces an output or performs another function in accordance with the rules for the control ball 51. In embodiments where the strings 50 are not displayed, then a touch anywhere on the touch and display screen 15 outside of the control ball 51 is interpreted as an equivalent to the selection of all strings or as a generation of another sound according to the configuration of the digital guitar. In some configurations, an extended touch in the area outside of the strings 50 may actuate outputs corresponding to each of the buttons 2 pressed. In some configurations a dragging touch in the area outside of the strings 50 may alter a parameter, such as pitch, according to the position of the user's finger relative to the initial position of the touch on the x axis.

In some embodiments a player can control a parameter of the digital guitar by the amount of pressure applied to the display screen 15 over the strings 50 and/or by the amount of pressure applied to the screen in the regions 52 and 53. For example, the amount of pressure may control the volume (or velocity) parameter. Alternatively, the amount of pressure may control the pitch or distortion. Other parameters may be controlled and this may be a configurable aspect of the processing unit 30. The parameter influenced by pressure may vary depending on the location where the display screen 15 is touched. For example pressure may control volume in region 52 but control distortion in region 53. In another example, pressure may control pitch in one region of the strings 50 and distortion in another region of the strings 50. It will be appreciated that, depending on the type of touch sensor used for the displace screen 15, the surface area of each touch may be used as an alternate, or additional, parameter to touch pressure. Velocity is a parameter used with digital musical instruments to designate how hard a note is played. For example, on a piano, the harder a note is pressed the higher the velocity and hence the louder the volume. However, velocity does not equate simply to volume because the volume parameter may also influence the tone of the sound. In the case of a guitar, the harder a string is plucked, the greater the velocity.

The control ball 51 allows x and/or y and/or z axis control over parameters of the digital guitar. The x and y axis control is achieved through movement in the x direction and the y direction respectively. The z axis control is achieved through detection of the pressure applied to the control ball 51. The control ball 51, when provided in conjunction with the strings 50 may have priority over the strings 50, so that if the control ball 51 overlaps the strings 50, the processing unit 30, 130 treats a touch in the area of overlap as a user input for the control ball 51, not the strings 50.

When the player of the digital guitar touches the control ball 51, he or she can drag it to different positions on the display screen 15. The effect of moving the control ball 51 across the display screen 15 is a configurable aspect of the processing unit 30, 130. An example is that movement in the x-axis direction controls the filter cut-off or phase control of a music synthesizer. Another example is movement in the y-axis direction controlling the pitch or tone of the sounds that are output. The z-axis may control the volume. The control ball may implement one, two or all three of these parameters or provide for control over other parameters. Accordingly, the player of the digital guitar may commence generation of a note, chord or other sound by touching and holding the touch and display screen 51 and then by touching and moving the control ball 51 vary the sound characteristics of the note, chord or other sound. After the control ball 51 the player may release the touch that commenced generation of the sound output, with the digital guitar continuing to generate the sound output until the control ball 51 is released.

The MIDI protocol currently is limited to values in the range 0 to 127. To reflect this, the touch and display screen may be divided into 128 sections in both the x axis and y axis directions, with movement across a section reflecting a new value in the MIDI protocol. Similarly, a detectable pressure range on the display screen 15 may be divided into the same range. It will be appreciated that alternate protocols with a greater range of values, such as OSC protocol, could also be used.

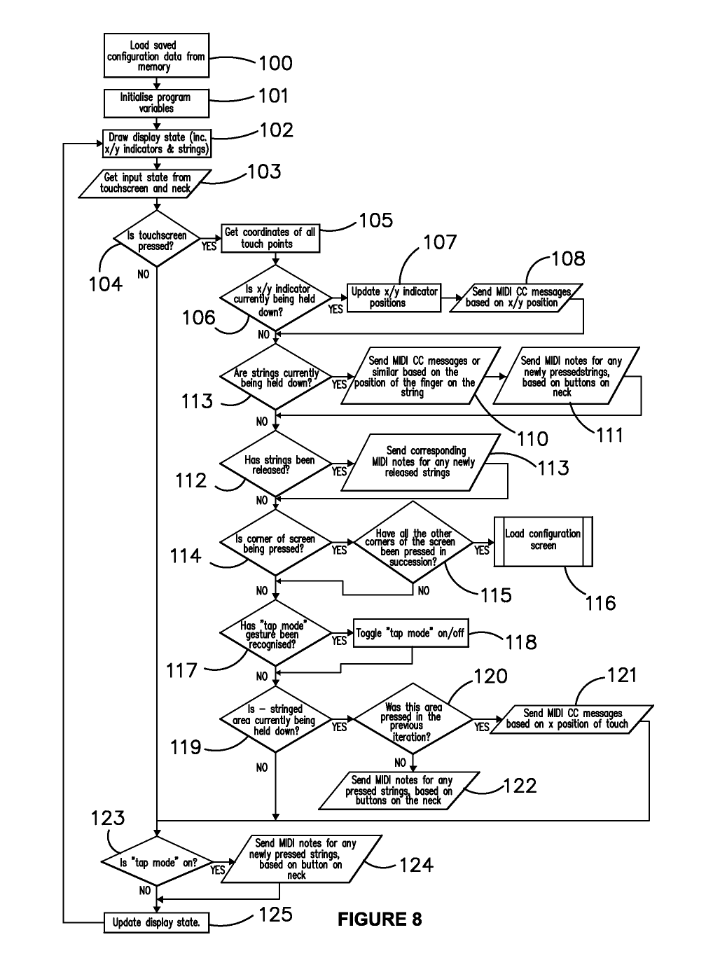

FIG. 8 show a flow diagram of one embodiment of a process that may be implemented by the processing unit 30, 130. Not all control aspects described above are included in FIG. 8, for example no reference is made to the detection of pressure. However, alternative flow diagrams and software implementations of these alternative flow diagrams that include the additional control aspects will be readily apparent from the description herein.

In step 100, the configuration of the processing unit 30 (or processing unit 130) is loaded from non-volatile memory 36. In one embodiment, each time the digital guitar is powered off, it saves its current configuration to the non-volatile memory 36 and loads this configuration when powered on again. The program variables are initialised in step 101. The program variables include the position of the control ball 51 (referred to as the ‘X/Y indicator’ in FIG. 8, whether ‘tap mode’ is on, string tuning and the current MIDI settings.

In step 102, the touch and display screen 15 is controlled to display the control ball 51 and the strings 50. Any other material that is to be displayed on the display screen 15, for example artwork, is also displayed.

In step 103, the processing unit 30, 130 monitors, at the previously mentioned sample rate, the inputs to it from the micro-switches 26 via processing unit 29, for the presence of a logical high on a row and column conductor that indicates that one or more buttons have been depressed. In step 104, the processing unit 30, 130 detects a touch on the touch and display screen 15 and proceeds to step 105 where the co-ordinates of each touch point on the touch and display screen 15 are determined. If no depression is detected, the process proceeds to step 123.

In step 106, the processing unit 30, 130 compares the coordinates of the one or more touch points determined in step 105 to the current display position of the control ball 51. If there is a match, then the process proceeds to step 107. By making this determination before the determination of whether there is a touch over the strings 50, the control ball 51 is given priority over the strings. If there is no match, then the process proceeds to step 109.

In step 107, the displayed position of the control ball 51 on the touch and display screen 15 is updated as the position of the touch detected in step 106 moves across the touch and display screen 15. Also, in step 108, the relevant MIDI control messages are generated to effect a change in the parameter that the digital guitar is configured to control through the control ball 51. As previously described, this may be a sound parameter such as distortion or pitch. The process proceeds from step 108 to step 109 immediately. In other words, the processing unit 30, 130 does not await release of the touch detected in step 106 before moving on to step 109.

In step 109, the processing unit 30, 130 monitors whether a touch on the touch and display screen 15 has been detected in the region of the displayed strings 50. If a touch is detected on the strings, the process proceeds to step 110. If no such touch is detected, the process proceeds to step 112.

In step 110, the relevant MIDI control messages are generated in response to detection of the strings currently being held down a particular position. As explained herein above, the position of touch along the strings 50 may affect the distortion parameter, with touches towards one end of the strings indicating that sounds should be generated to correspond to a classical guitar, whereas touches near at the other end of the strings indicate that distortion should be introduced. In step 111, the MIDI notes are generated by the processing unit 30, 130, dependent on the determination in step 110 and the determination in step 103.

In step 112, the processing unit 30, 130 monitors for the release of any previously touched strings. Upon detection of release of a string, the processing unit 30, 130, in step 113, indicates this by sending the MIDI note for the released string. Otherwise, the process proceeds directly to step 114.

Steps 114 to 116 are the entry into a configuration mode. In this embodiment, the consideration mode is entered by touching all four corners of the touch and display screen 15. If this occurs, as detected in steps 114 and 115, the processing unit 30, 130 causes the touch and display screen 15 to display a configuration screen, receives inputs through the touch and display screen 15 and alters the parameters of operation of the digital guitar responsive to the received inputs.

In step 117, the processing unit 30, 130 monitors for a gesture that causes it to toggle between the “tap mode” (see herein above) being on and off. For example, the gesture may be a three-finger touch in the area outside of the strings 50 on the touch and display screen 15. Of course, other gestures may be used. If the gesture is detected, the tap mode is switched on if it is currently off and is switched off if it is currently on (step 118).

In step 119, the processing unit 30, 130 monitors whether a touch is detected in either region 52 or region 53. If a touch is detected in either of these regions, step 120 involves determining whether the touch was also detected as present during the immediately preceding iteration through the process. If the touch was present in the previous iteration, then this is interpreted as a sound control user input and the relevant MIDI control messages are generated responsive to movement of the touch in the x-direction on the touch and display screen 15 (step 121). As previously described, movement in the x-direction may control sound parameters like the filter cut-off, distortion or pitch. If the touch was not present in the previous iteration, then this is interpreted as the commencement of play of the relevant notes, as indicated by the detection, in step 103, of which buttons 2 have been depressed. In this case the MIDI notes are generated for output from the digital guitar (step 122).

Step 123 is a decision point for whether or not the digital guitar is currently configured in “tap mode”. If the digital guitar is configured in tap mode, then the MIDI notes are generated based on the determination, in step 103, of the buttons on the neck that have been depressed, even if no input is received on the touch and display screen 15. If the digital guitar is not in tap mode, then in this embodiment notes are only generated when the touch and display screen 15 registers a touch on the strings or in the non-stringed area (steps 109 to 111 and steps 119 to 122).

In step 125 the processing unit 30, 130 updates the state of the screen component of the touch and display screen 15 to cause the display to, in step 102, display any required new information or other changes. Examples include displaying the new position of the control ball 51 if it was moved and changing to the configuration screen if the decision points in steps 114 and 115 are both affirmative.

The person skilled in the art will appreciate that various modifications may be made in the details of design and construction without departing from the scope and ambit of the invention. In particular, whilst the circuitry provided in FIG. 3 is representative of one way in which to put together an apparatus according to the invention, there may be many other ways of connecting the electrical components that a person skilled in the art would appreciate as being within the scope of this invention. The software loaded into the non-volatile memory 36 of the digital guitar 1, 1A in one embodiment is Linux based or adapted to run on a Linux operating system embedded in the memory of the digital guitar. The person skilled in the art would appreciate that there are other software solutions that would effectively drive the device, and that come within the scope of the present invention.

What is claimed is:

1. A stringless digital guitar comprising:—
input means adapted to receive:
(i) the users fingers (or other input type such as a stylus) and generating electrical signals indicating the position of the fingers (or stylus) relative to at least an x and y axes, and where the electrical signals are capable of being processed; and
(ii) settings desired by the user;
a display for indicating the settings of the digital instrument; and
a microcontroller adapted to receive the electrical signals representing the position of one or more fingers of the user and inputted settings, and generate as a result, electrical output signals representative of sound.

2. The stringless digital guitar of claim 1 comprising a MIDI output port, wherein the output signals comprise MIDI protocol signals.

3. The stringless digital guitar of claim 2 wherein the input means are comprised, at least, of a touch sensor pad capable of registered input on at least its X and Y axes.

4. The stringless digital guitar of claim 3 wherein the input means further comprises an array of buttons.

5. The stringless digital guitar of claim 1 wherein the input means comprises a touch and display screen which functions as a display of the digital instrument and as an input for receiving the settings desired by the user.

6. The stringless digital guitar of claim 1 comprising a USB port in communication with the microcontroller, wherein the microcontroller is configured to receive at least one of software updates, and values for said settings, as data through the USB port.

7. A digital guitar comprising:
a guitar body;
a neck extending from the guitar body;
an array of input buttons along the neck;
a touch pad on the guitar body;
a guitar controller in communication with the array of input buttons and the touch pad;
wherein the guitar controller is configured to receive electronic signals indicating detection of touch on the touch pad and in response generate output signals representative of sounds, the output signals defining particular sound characteristics dependent on input from the input buttons.

8. The digital guitar of claim 7, wherein said output signals define particular sound characteristics dependent on both input from the input buttons and the position of the detected touch on the touch pad.

9. The digital guitar of claim 8, wherein touches in different positions along a first axis of the touch pad affect a first said sound characteristic and touches in different positions along a second axis of the touch pad affect a second said sound characteristic, different from the first sound characteristic.

10. The digital guitar of claim 8, wherein the touch pad detects variations in pressure applied to it by a touch and wherein said output signals define particular sound characteristics dependent on the detected pressure.

11. The digital guitar of claim 9, wherein the touch pad detects variations in pressure applied to it by a touch and wherein variations in the detected pressure affect a third said sound characteristic, different from the first and second sound characteristics.

12. The digital guitar of claim 11, wherein the first sound characteristic is distortion, the second sound characteristic is pitch.

13. The digital guitar of claim 12, wherein the third sound characteristic is volume.

14. The digital guitar of claim 7, wherein the touch pad is configured to distinctly detect a plurality of simultaneous touches, the digital guitar further comprising a display screen that, with the touch pad, provides a touch and display screen, wherein the display screen is controlled by the guitar controller to display indicia representative of strings and wherein the output signals define different particular sound characteristics dependent on touches received on the touch pads corresponding to the position of different displayed strings or combinations of strings.

15. The digital guitar of claim 14, wherein the indicia representative of the strings fills less than all of the touch and display screen and wherein the guitar controller is configured to, in response to detection of a touch in one or more regions outside of the strings, generate output signals defining sound characteristics corresponding to the sound characteristics that would be generated if all strings were touched.

16. The digital guitar of claim 7, wherein the guitar controller is configured to receive signals from the touch pad indicating detection of a sliding movement on the touch pad and in response vary the output signals.

17. The digital guitar of claim 16, wherein the guitar controller is configured to vary the output signals to represent simultaneous change of two different sound characteristics, wherein the extent of change of each of the two different sound characteristics is dependent on the direction of the sliding movement.

18. The digital guitar of claim 7, wherein the guitar controller is configured to receive signals from the touch pad indicating detection of a change in pressure over time of a touch on the touch pad and to vary the output signals responsive to the change in pressure.

19. A computer program product comprising computer-readable instructions to cause a digital guitar controller to:
in response to receipt of electronic signals from a touch pad that indicate a touch on the touch pad, generate output signals representative of commencement of sound; and
receive input from an array of buttons and generate different said output signals dependent on the received input from the array of buttons.

20. The computer program product of claim 19, further comprising instructions to cause a digital guitar controller to generate different said output signals so as to represent a change in the sound after its commencement in response to electronic signals from the touch pad indicating movement of a touch across the touch pad.

21. The computer program product of claim 20, wherein the instructions cause the digital guitar controller to
generate output signals to represent a first change in the sound responsive to electronic signals from the touch pad indicating movement in a first direction; and
generate output signals to represent a second change in the sound, different from the first change in the sound, responsive to electronic signals from the touch pad indicating movement in a second direction, different from the first direction.

22. The computer program product of claim 21, wherein the instructions cause the digital controller to
generate output signals to represent a third change in the sound responsive to electronic signals from the touch pad indicating a change in pressure of a touch on the touch pad.

23. The stringless digital guitar of claim 1 wherein the output signals comprise open sound control (OSC) signals.

24. The digital guitar of claim 12, wherein the third sound characteristic is velocity.
